(19) United States
(12) Patent Application Publication
(10) Pub. No.: US 2007/0074916 A1
(43) Pub. Date: Apr. 5, 2007

(54) SYSTEM AND METHOD FOR SENSING THE POSITION OF A POINTING OBJECT USING A CONDUCTIVE SHEET

(76) Inventor: Bernard Joseph Hall, Elizabeth, NJ (US)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/538,024

(22) Filed: Oct. 2, 2006

Related U.S. Application Data
(60) Provisional application No. 60/722,544, filed on Sep. 30, 2005.

(51) Int. Cl. G08C 21/00

(52) U.S. Cl. 178/18.06

(57) ABSTRACT

A position input device includes a conductive resistive sheet as a sensing element and at least four terminals on the conductive sheet which are spaced apart from each other. The four terminals received oscillating electric field signals that correspond to the three dimensional position of a pointing object based on a capacitive coupling of the pointing object to the conductive sheet. A processor generates the three dimensional position data of the pointing object hovering over the conductive sheet based on oscillating output signals from the four terminals.

### CROSS REFERENCE TO RELATED APPLICATIONS

This application claims priority to U.S. provisional patent application No. 60/722,544, filed Sep. 30, 2005, which is hereby incorporated by reference.

### FIELD OF THE INVENTION

The present invention relates to an input device and more particularly a position sensing input device.

### BACKGROUND OF THE INVENTION

Two-dimensional position sensing input devices are widely used in today's computer systems. A popular input device that is installed in many portable computers is a capacitive sensing device that is used to control a cursor on a display.

A sensing layer of the capacitive sensing device has an array of conductive metal electrodes. When a user's finger is placed over the metal electrode array, capacitance forms between the finger tip and the electrodes. In the capacitive sensing device, a relatively complex processor containing analog and digital electronic circuits measures the amount of capacitance in each of the electrodes. By measuring which electrodes have the most capacitance, the sensing device calculates the x-y position of the user's finger tip. The calculated position is then reported to the computer in the form of cursor motion.

Although the capacitive sensing device is generally accurate, it is a very complex device requiring a complex metal electrode array and electrical circuits. The complexity results in a device that is very expensive to manufacture and potentially less durable.

Another disadvantage of the conventional capacitive sensing device is that it senses only two dimensions (in x and y direction). For flexibility and for certain applications such as a touch screen of an automatic teller machine, it may be desirable to provide a sensor capable of outputting a third dimension (z-direction) such that the height of a pointing object can be detected.

Moreover, for position sensing directly over a display, the conventional capacitive sensing device cannot be used because the metal electrode array would interfere with viewing of the display.

Therefore, there is a need to provide a position sensing input device that addresses the above noted problems.

### SUMMARY OF THE DISCLOSURE

A position input device according to the present invention includes a conductive resistive sheet as a sensing element and at least four terminals on the conductive sheet which are spaced apart from each other. The four terminals receive oscillating electric field signals that correspond to the position of a pointing object relative to the conductive sheet. A processor receives output signals from the four terminals and generates an x,y position data of a pointing object hovering over the conductive sheet. The x,y position data can be in the form of Cartesian coordinates or polar coordinates.

The position input device is also capable of determining the pointing object's position in the z-direction simply by using the output signal of at least one of the four terminals on the conductive sheet.

### BRIEF DESCRIPTION OF THE DRAWINGS

FIG. 1 is an exemplary block diagram of a position sensing input device connected to a computer according to the present invention.

FIG. 2 is a cross-sectional view of a sensor element for the position sensing input device of FIG. 1 along the line defined by Xa and Xb.

FIG. 3 is an alternate embodiment of a portion of the position sensing input device of FIG. 1.

FIG. 4A is a graph illustrating the linear relationship between the signal strength of sensing elements and position of a pointing object in either x-direction or y-direction.

FIG. 4B is a graph illustrating the non-linear relationship between the signal strength of sensing elements and position of a pointing object in z-direction.

FIG. 5 illustrates the triangle geometric relationship formed by the input terminals of the input device of FIG. 1 and the pointing object.

FIG. 6 is an alternate embodiment of a sensor arrangement according to the present invention.

### DETAILED DESCRIPTION OF THE INVENTION

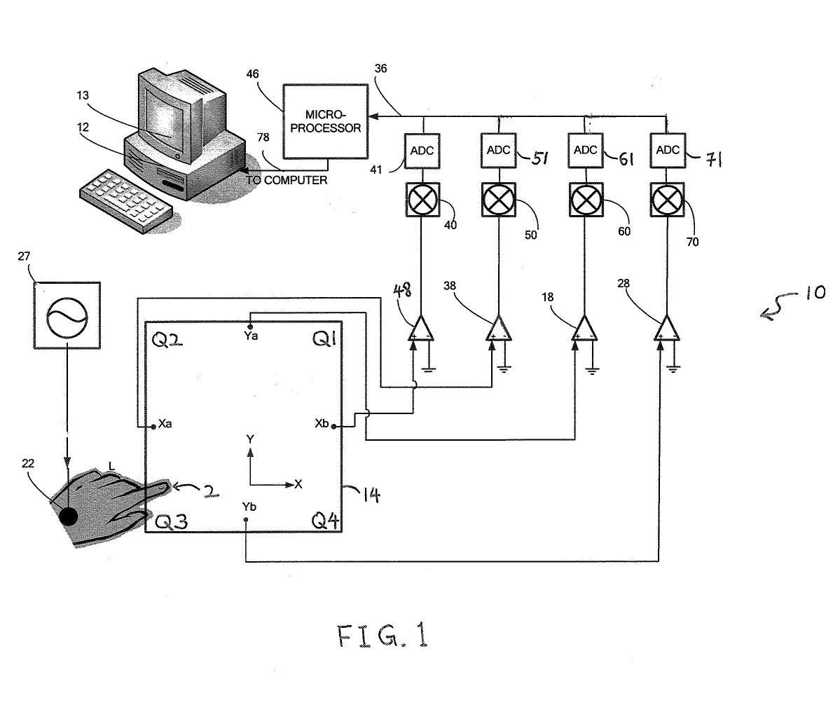

Referring to FIG. 1, reference numeral 10 generally designates a position sensing input device of the present invention which is used with a computer 12, 13.

The present position sensing input device 10 detects two or three dimensional position of a pointing object 2. As shown in FIG. 1, an oscillator 27, whose ground is common to the circuits of the position input device 10, is connected to one body part of a user such as a hand through an injection electrode 22. The oscillator generates an oscillating signal having a frequency in the range of 10 Hz to 100 kHz. The oscillating signal travels through the user's body to an index finger tip 2 which is used as the pointing object in FIG. 1.

A conductive, resistive sheet 14 is a resistive material having a resistivity in the range of 10 to 10,000 Ohm/square inch. The conductive sheet can be transparent or opaque depending on the application. For example, the conductive sheet is transparent if it is applied over a display 13 of a computer 12 for use as a touch screen in an automatic teller machine. The conductive sheet can be, for example, Agfa Orgacon™ EL/350, Agfa Orgacon™ EL/1500 or the like which are readily available from Agfa-Gevaert Group in Mortsel, Belgium. In another form, the conductive sheet 14 can be an ink or coating that can be applied on top of the display 13 such as Eikos™ transparent conductive ink available from Eikos Corporation of Franklin, Mass.

There are four terminals which divide the conductive sheet 14 into four quadrants Q1, Q2, Q3 and Q4. They are Xa, Xb, Ya and Yb. Terminals Xa and Xb divide the conductive sheet 14 equally into upper (Q1,Q2) and lower (Q3,Q4) halves. Terminals Ya and Yb divide the conductive sheet 14 equally into left (Q2, Q3) and right (Q1, Q4) halves.

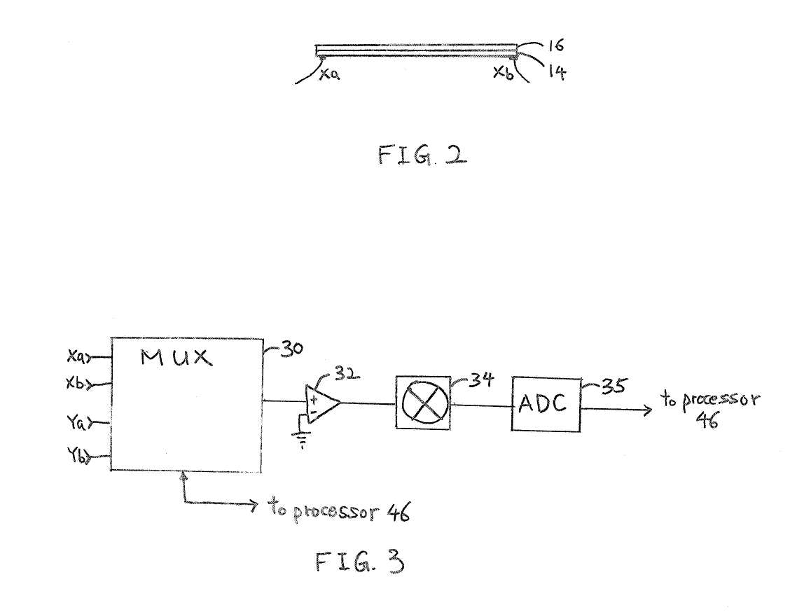

Typically, an insulating layer 16 (see FIG. 2) covers the conductive sheet 14 to prevent the pointing object 2 from contacting and possibly damaging the sheet.

When the pointing object 2 is positioned above the conductive sheet 14, the oscillating signal couples to the conductive sheet and the coupled signal is concentrated in the region directly above the pointing object 2 (in a region around an imaginary line from the pointing object and forming a 90 degree angle to the sheet). This capacitively coupled signal then propagates through the conductive sheet 14 and arrives at each of the four terminals at varying strengths depending upon the distance each signal has to travel.

The four terminals Xa, Xb, Ya and Yb are respectively connected to high gain amplifiers 38, 48, 18 and 28. The outputs of the amplifiers are respectively connected to synchronous demodulators 50, 40, 60, 70 which are in turn respectively connected to ADC (analog to digital converters) 51, 41, 61, 71. The outputs of the ADC's are connected to a processor 46 over a common bus 36. The processor 46 includes memory (not shown) for storing sensor data, generates the x,y,z position of the pointing object 2 and transmits the position data to the computer 12 over a communication line 78.

A synchronous demodulator is a demodulator that runs at the same frequency as the input frequency (i.e., the frequency of the oscillator 27). The simplest form of this is a rectifier. In the embodiment shown, since the oscillating frequency is known, the synchronous demodulator uses a switch that switches from positive to negative at the zero crossings in the input signal. The output for a sinusoidal input signal is simply a rectified sinusoidal. This effectively performs a demodulation on the signal—transferring the useful information (amplitude in the present case) from a high frequency down to DC. The high oscillating frequency signal is useful for two reasons: 1. it allows the signal to propagate through the capacitive coupling of the sensing elements; and 2. it allows the amplifiers to operate in a relatively noise free frequency band. Thus, the synchronous demodulator enables easy determination of the signal amplitude by a standard analog to digital converter.

As an alternative embodiment (see FIG. 3), instead of using a set of four amplifiers, four synchronous demodulators and four ADC's, a multiplexer 30 can be used to sequentially select inputs from the four input terminals Xa, Xb, Ya and Yb to reduce the number of components. As shown in FIG. 3, only one amplifier 32, one synchronous demodulator 34 and one ADC 35 connected in series to the multiplexer 30, is required. The control input of the multiplexer 30 is connected to the processor 46 which controls connection of the multiplexer inputs to the multiplexer output.

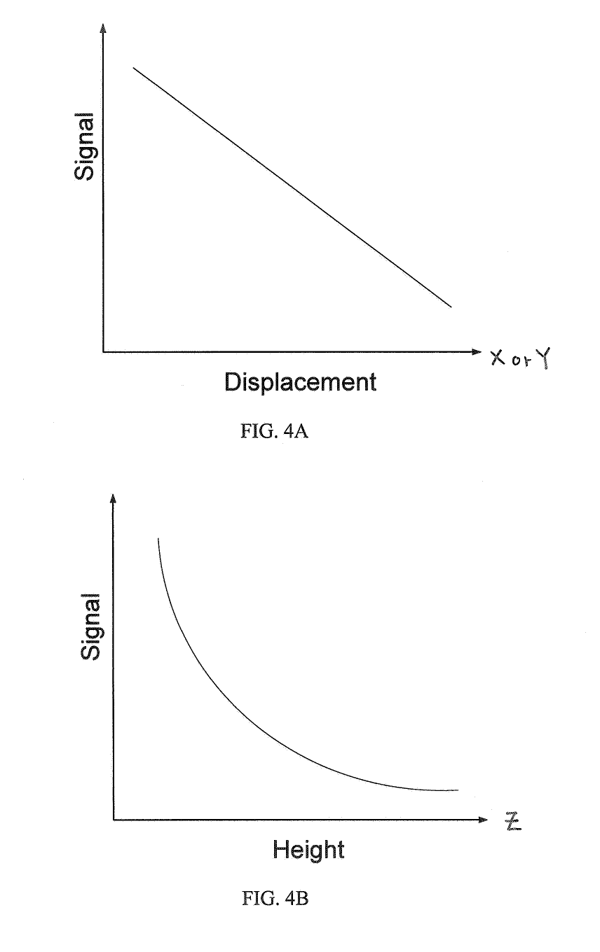

A more detailed operation of the position sensing input device 10 will now be described. As the pointing object 2 moves over an x-y plane defined by the conductive sheet 14, the signals arriving at each of the four terminals Xa, Xb, Ya and Yb vary linearly with the x-y movement of the pointing object. For example, as the pointing object 2 moves from terminal Xa to Xb, the signal being received at Xa decreases linearly as shown in FIG. 4A.

By contrast, as the pointing object 2 moves away from the x-y plane in a z-direction relative to the conductive sheet 14, the signals arriving at each of the four terminals Xa, Xb, Ya and Yb vary non-linearly, that is inversely proportional to the z-movement (signal=1/z) as shown in FIG. 4B.

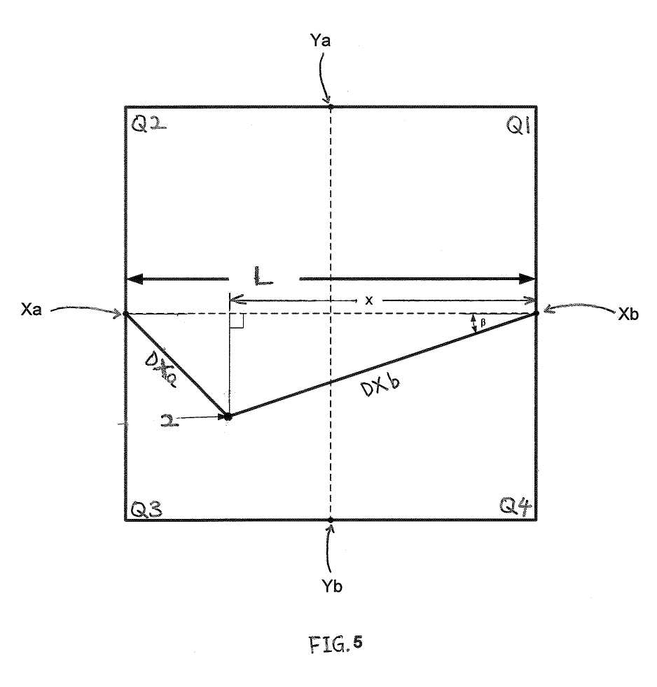

One example of determining an x-position of the pointing object 2 will now be described with reference to FIG. 5. As shown, the pointing object 2 is positioned over quadrant Q3.

The first step is to determine the quadrant in which the pointing object 2 is located. This is done by using the digital signal outputs of ADC's 51, 41, 61, 71 which represent the analog signal outputs from terminals Xa, Xb, Ya and Yb, respectively. The following logic is used:

If Xb>Xa AND Ya>Yb, then object 2 is in Q1.

If Xa>Xb AND Ya>Yb, then object 2 is in Q2.

If Xa>Xb AND Yb>Ya, then object 2 is in Q3.

If Xb>Xa AND Yb>Ya, then object 2 is in Q4.

Next, the z-position of the pointing object 2 is obtained by the following equation:
Z=Xa+Xb+Ya+Yb (1)

Next, an adjustment to the signal outputs of the four terminals Xa, Xb, Ya and Yb are made to remove the z-component in the output signals. The adjusted signal outputs represent signals that would be observed if the pointing object was touching the insulating layer 16 (i.e., Z position=0). The following formulas are used:
DXa=Xa*1/Z (2)
DXb=Xb*1/Z (3)
DYa=Ya*1/Z (4)
DYb=Yb*1/Z (5)

The adjusted signal outputs are then converted to distances using a calibration factor C such that:
DXa=DXa*C (6)
DXb=DXb*C (7)
DYa=DYa*C (8)
DYb=DYb*C (9)

Based on the adjusted signal outputs from equations 6 through 9, a first order X position data are calculated based on mathematical relationships (in particular the law of cosine) of a triangle formed by distances represented by DXa, DXb and L as shown in FIG. 5:
DXa²=L²+DXb²−2*L*DXb*Cos(β) (10)
β=Cos⁻¹ [(L²+DXb²−DXa²)/(2*L*DXb)] (11)
Since Cos(β)=x/DXb, x=DXb*[(L²+DXb²−DXa²)/(2*L*DXb)] (12)

Using a coordinate system with the origin at the center of the conductive sheet 14, the X position would then be given simply by X-position =L/2−x.

The above calculation is shown for determining the X-position data, but the same calculation can be used in order to calculate the Y position.

For the z-position, the summed data Z (sum of Xa, Xb, Ya and Yb) is multiplied by a constant such as 1/K.

It should be noted that the assumptions of signal output relative to the x, y and z movement are reasonable, but should be considered as first order approximations. More precise X, Y positioning is achievable using second and higher order corrections to the assumptions.

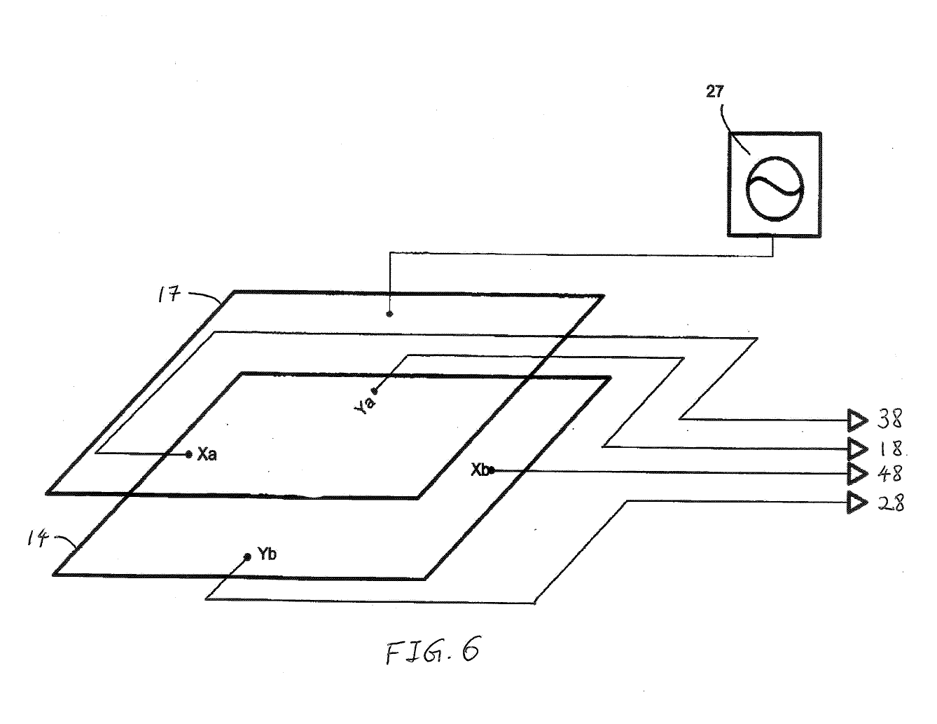

FIG. 6 is an alternative embodiment of a sensor arrangement according to the present invention. Instead of using the injection electrode 22, the sensor arrangement of FIG. 6 uses a conductive material 17 which is spaced from the conductive sheet 14 and is connected to the oscillator 27. As shown, the conductive material 17 is another conductive sheet either overlying or underlying the conductive sheet 14 although the material can be other types such as a strip or a transparent grid pattern. An oscillating electric field flow is established between the two conductive sheets 14 and 17. The pointing object 2 placed over the two sheets disturbs the electric field flow therebetween. Similar calculations are used to generate the x,y,z position data, except that the negative slope shown in FIG. 4A would now be a positive slope.

As can be seen above, compared to the conventional capacitive sensor devices, the position sensing input device 10 according to the present invention is very simple in design because it utilizes a single conductive sheet and few sensor input terminals thereon as the sensor element. As a result, the x,y,z position calculations are relatively straight forward without requiring complex processing circuits. The simple design and position calculations mean that the input device 10 can be very inexpensive to manufacture and be very durable.

Also, because the conductive sheet can be transparent, the input device according to the present invention can be placed on top of a display for use as a touch-sensitive screen for a variety of applications such as automatic teller machines and ticket purchasing kiosks. In addition, the input device according to the present invention can be implanted as a three dimensional position sensing device without requiring additional circuitry.

The foregoing specific embodiments represent just some of the ways of practicing the present invention. Many other embodiments are possible within the spirit of the invention. For example, although the input terminals Xa, Xb, Ya, and Yb are placed at mid-points of each side of the conductive sheet 14, they can be placed at other places such as the four corners. There may be less or more than four sensor input terminals depending on particular applications. Accordingly, the scope of the invention is not limited to the foregoing specification, but instead is given by the appended claims along with their full range of equivalents.

What is claimed is:

1. A position input device comprising:
a conductive sheet;
first and second terminals positioned on the conductive sheet and on opposite sides from each other;
third and fourth terminals positioned on the conductive sheet and on opposite sides from each other, the third terminal being on one side of an imaginary line drawn between the first and second terminals and the fourth terminal being on the other side of the imaginary line, wherein the first, second, third and fourth terminals receive oscillating electric field signals that correspond to the position of a pointing object relative to the conductive sheet; and
a processor connected to the first, second, third and fourth terminals and operable to generate a first position of the pointing object in a first direction and a second position of the pointing object in a second direction perpendicular to the first direction based on output signals from the first, second, third and fourth terminals.

2. The position input device according to claim 1, wherein the processor generates the first position of the pointing object based on a mathematical relationship related to a triangle defined by the first terminal, the second terminal and the pointing object.

3. The position input device according to claim 1, wherein the processor generates a third position of the pointing object in a third direction that is perpendicular to both the first and second directions based on the output signal from at least one of the first, second, third and fourth terminals.

4. The position input device according to claim 3, wherein the processor generates the third position based on the output signals from the first, second, third and fourth terminals.

5. The position input device according to claim 3, wherein the processor generates the first position of the pointing object based on a mathematical relationship related to a triangle defined by the first terminal, the second terminal and the pointing object.

6. The position input device according to claim 1, wherein the processor:
generates the first position based on the output signals from the first and second terminals; and
generates the second position based on the output signals from the third and fourth terminals.

7. The position input device according to claim 1, further comprising:
a multiplexer having its first and second inputs connected to the first and second terminals; and
an A/D converter having an input connected to the output of the multiplexer.

8. The position input device according to claim 1, wherein the conductive sheet includes a transparent sheet disposed on a display.

9. The position input device according to claim 1, wherein the pointing object is a movable body part of a user, further comprising:
an oscillator that generates an oscillating signal;
a signal injection electrode connected to the oscillator and operable to establish an oscillating electric field about the movable body part.

10. The position input device according to claim 1, wherein the pointing object is a movable body part of a user, further comprising:
a conductive material spaced from the conductive sheet;
an oscillator connected to the conductive material to create an oscillating electric field between the conductive material and the conductive sheet.

11. The position input device according to claim 1, wherein the conductive sheet has a resistance of 10 to 10,000 Ohms per square inch.

12. The position input device according to claim 1, further comprising an insulating layer overlying the conductive sheet to prevent the pointing object from contacting the conductive sheet.

13. The position input device according to claim 1, further comprising:
a synchronous demodulator having an input connected to the first terminal; and
an A/D converter connected between the processor and the synchronous demodulator.

14. A position input device comprising:
a conductive sheet having a predetermined resistivity;
an insulating layer overlying the conductive sheet;
first and second terminals positioned on the conductive sheet on opposite sides from each other;
third and fourth terminals positioned on the conductive sheet on opposite sides from each other, the third terminal being on one side of an imaginary line drawn between the first and second terminals and the fourth terminal being on the other side of the imaginary line, wherein the first, second, third and fourth terminals receive oscillating electric field signals that correspond to the position of the pointing object relative to the conductive sheet; and
a processor connected to the first, second, third and fourth terminals and operable to generate position data representing a three dimensional position of the pointing object based on output signals from the first, second, third and fourth terminals.

15. The position input device according to claim 14, wherein the processor generates at least a part of the position data based on a mathematical relationship related to a triangle defined by the first terminal, the second terminal and the pointing object.

16. The position input device according to claim 14, wherein the processor generates a z-position of the position data based on the output signal from at least one of the first, second, third and fourth terminals.

17. The position input device according to claim 16, wherein the processor generates the z-position of the position data based on the output signals from the first, second, third and fourth terminals.

18. The position input device according to claim 14, wherein the processor:
generates an x-position of the position data based on the output signals from the first and second terminals; and
generates a y-position of the position data based on the output signals from the third and fourth terminals.

19. The position input device according to claim 14, further comprising:
a multiplexer having its first and second inputs connected to the first and second terminals; and
an analog-to-digital converter having an input connected to the output of the multiplexer.

20. The position input device according to claim 14, wherein the conductive sheet includes a transparent sheet disposed on a display.

21. The position input device according to claim 14, wherein the pointing object is a movable body part of a user, further comprising:
an oscillator that generates an oscillating signal;
a signal injection electrode connected to the oscillator and operable to establish an oscillating electric field about the movable body part.

22. The position input device according to claim 14, wherein the pointing object is a movable body part of a user, further comprising:
a conductive material spaced from the conductive sheet;
an oscillator connected to the conductive material to create an oscillating electric field between the conductive material and the conductive sheet.

23. The position input device according to claim 14, wherein the conductive sheet has a resistance of 10 to 10,000 Ohms per square inch.

24. The position input device according to claim 14, further comprising:
a synchronous demodulator having an input connected to the first terminal; and
an A/D converter connected between the processor and the synchronous demodulator.

25. In a position input device having a conductive sheet, first and second terminals positioned on the conductive sheet and on opposite sides from each other and third and fourth terminals positioned on the conductive sheet and on opposite sides from each other, wherein the first, second, third and fourth terminals receive oscillating electric field signals that correspond to the position of a pointing object, a method of determining the position of the pointing object comprising:
receiving the oscillating electric field signals from the first, second, third and fourth terminals positioned on the conductive sheet;
determining an x-position of the pointing object based on output signals from the first and second terminals and based on a mathematical relationship related to a triangle defined by the first terminal, the second terminal and the pointing object; and
determining a y-position of the pointing object based on output signals from the third and fourth terminals and based on a mathematical relationship related to a triangle defined by the third terminal, the fourth terminal and the pointing object.

26. The method according to claim 25, further comprising generating a z-position of the pointing object based on an output signal from at least one of the first, second, third and fourth terminals.

27. The method according to claim 26, wherein the step of generating a z-position includes generating the z-position based on the output signals from the first, second, third and fourth terminals.
